(19) United States
(12) Patent Application Publication
(10) Pub. No.: US 2004/0066933 A1
(43) Pub. Date: Apr. 8, 2004

(54) Method and device for preventing signal loss in unterminated bridge taps

(76) Inventors: Ross A. Jeffery, Uxbridge (CA); Marc C. Jairam, Scarborough (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/265,643

(22) Filed: Oct. 8, 2002

(51) Int. Cl. H04M 1/00; H04M 3/00

(52) U.S. Cl. 379/380

(57) ABSTRACT

A method and device for avoiding signal cancellation caused by a unterminated bridge taps, provides a cable extension, preferably in the form of a pair of coils having an impedance matching the impedance of the telephone wire, respectively coupling the conductors in each bridge tap to the incoming ring and tip conductors. The cable extension increases the effective length of the bridge tap, thereby eliminating destructive interference between the incoming telecommunications signal and the signal reflected from the unterminated end. In the preferred embodiment the cable extension is adaptable to various lengths by a switching network.

### FIELD OF THE INVENTION

This invention relates to telecommunications. In particular, this invention relates to a method and apparatus for preventing loss of a modulated signal in an unterminated bridge tap.

### BACKGROUND OF THE INVENTION

Many telecommunications systems distribute high frequency modulated signals over twisted-pair telephone wires. For example, Digital Subscriber Line (DSL) services distribute QAM-modulated carrier signals to subscribers at a frequencies of 7.5 MHz in accordance with ETSI and ANSI 997-99. These signals are fed into a local bridge, for example a junction box in a business or residence, from which “bridge taps” couple the incoming telephone lines to the various points in the premises where the telecommunications service is to be accessed. A typical home or office is likely to have bridge taps for telephone services leading to many rooms, and often additional bridge taps for computer connections, each terminating at an RJ-11 receptacle to which a telephone device (e.g. telephone, facsimile machine, answering machine, computer modem etc.) may be coupled to use the service.

Typically not all telephone receptacles in a premises are used, and therefore some receptacles are not connected to a telephone device. When no telephone device is plugged into a receptacle, the bridge tap is unterminated, as shown at 6 in FIG. 1. This situation is common, and at conventional plain old telephone service (POTS) signal frequencies, in the order of 7 to 10 kHz, this does not cause any disruption of the telephone signal.

However, many regions are now equipped for the distribution of high frequency telephone signals such as DSL. Moreover, systems for the distribution of other types of services can distribute video signals over twisted-pair telephone wires at much higher frequencies, in the order of MHz and even tens of MHz, for example the audio/video redistribution system described in U.S. Pat. No. 6,038,425 issued Mar. 14, 2000 to Jeffery, which is incorporated herein by reference.

At these higher frequencies, unterminated bridge taps can present a serious problem. The telecommunications signal reflects back onto itself upon reaching the unterminated end of the bridge tap, so that the reflected signal and the incoming signal are superposed. In most cases this does not affect the incoming telecommunications signal. However, if the length of the unterminated bridge tap approximates an integer multiple of one-quarter of the wavelength of the incoming telecommunications carrier (for example one quarter, one half, three quarters or one complete wavelength of the carrier), the reflected signal will destructively interfere with the incoming signal.

For example, a 7.5 MHz carrier has a wavelength of 40 meters. One quarter of the carrier wavelength is therefore 10 meters (approximately 30 feet). If the premises receiving the signal has an unterminated bridge tap with a length approximating 10 meters, the carrier will reflect back onto itself and the reflected signal will destroy the incoming carrier due to the phase shift of the reflected signal relative to the incoming carrier. At such cable lengths the resulting destructive interference substantially or completely eliminates the incoming signal, effectively acting as a filter or dead short in the unterminated bridge tap which disrupts the telecommunications service in the entire premises.

One solution is to shunt the unused bridge tap with a termination impedance, for example a resistor, matching the impedance of the twisted pair telephone cable used for the bridge tap. This allows the signal to pass the bridge tap without reflection. However, it is not realistic to expect users to ensure that a termination device is inserted into a telephone receptacle whenever a telephone device is unplugged from the receptacle. Moreover, in many older premises unterminated bridge taps left over from previous subscribers exist within the walls of the structure, and it is not feasible to locate and terminate all such unused bridge taps, even where the subscriber is aware of their existence.

U.S. Pat. No. 5,517,523 issued May 14, 1996 to Nabors et al., which is incorporated herein by reference, discloses an equalizer circuit for compensating for delay distortion in a switched digital telephone line caused by an unterminated bridge tap. This device involves a complex circuit which requires precise timing in order to couple the delayed feedback signal with the input signal in a manner which eliminates the delay distortion component. Moreover, once installed the device is not adaptable to different frequencies.

Another solution is to detect the loss of signal caused by an unterminated bridge tap and vary the frequency of the incoming carrier to change its characteristic wavelength, so that one quarter of the carrier wavelength is no longer an integer multiple of the length of the unterminated bridge tap. For example, U.S. patent application Ser. No. 09/522,940 filed Mar. 10, 2000 by Jeffery, which is incorporated herein by reference, discloses a method of dynamically allocating a carrier frequency to a telecommunications signal in response to various line conditions, one of which could be signal loss due to one or more unterminated bridge taps. However, altering the carrier frequency to avoid signal loss in an unterminated bridge tap could subject the signal to other unfavourable line conditions, which may be less than ideal at the newly allocated frequency.

Accordingly, there is a need for a method and device for avoiding signal cancellation caused by signal reflection in unterminated bridge taps, which does not require user intervention or the reallocation of the carrier frequency.

### SUMMARY OF THE INVENTION

The present invention overcomes these disadvantages by providing a method and device for avoiding signal cancellation caused by a unterminated bridge taps, which does not require termination of the unterminated bridge tap or reallocation of the carrier frequency. The device of the invention is readily installed at the local bridge, avoiding the need to locate concealed unterminated taps, work behind walls or ceilings, or make provisions for proper termination when a telephone device is uncoupled from its receptacle.

The invention accomplishes this by providing a cable extension, preferably in the form of a coil having an impedance matching the impedance of the telephone wire, coupling one of the conductors in each bridge tap to the incoming ring or tip conductors, or a pair of coils having an impedance matching the impedance of the telephone wire, respectively coupling both conductors in each bridge tap to the incoming ring and tip conductors. The cable extension increases the effective length of the bridge tap so that the unterminated bridge tap is not an integer multiple of one quarter of the carrier wavelength, thereby eliminating destructive interference between the incoming telecommunications signal and the signal reflected from the unterminated end.

In the preferred embodiment the cable extension is adaptable to various lengths, for example by providing taps into intermediate points of the coils or by providing multiple coil pairs of differing lengths, coupled by a switching network which diverts the telecommunications signal through a selected length of the coil pair. This allows for the selection of a length of the cable extension, and thus an effective length for the unterminated bridge tap which is not an integer multiple of one quarter of the carrier wavelength, regardless of the carrier wavelength. The cable extension is selected so as not to interfere with the carrier, for example by matching the impedance of the bridge tap and maintaining the length of the extension within reasonable limits to avoid excessive attenuation. As a result, the telecommunications service can operate at a fixed frequency, or have the flexibility of carrier frequency reallocation such as that described in U.S. patent application Ser. No. 09/522,940, without limiting the available frequencies.

The present invention thus provides, for a bridge for coupling a pair of incoming telephone conductors to one or more bridge taps, each bridge tap having a conductor coupled to an incoming telephone conductor for distributing a telecommunications signal about a premises, a cable extension connected in series between at least one incoming telephone conductor and at least one respective bridge tap conductor.

The present invention further provides, for a bridge for coupling a pair of incoming telephone conductors to one or more bridge taps, each bridge tap having a conductor coupled to an incoming telephone conductor for distributing a telecommunications signal about a premises, a cable extension connected in series between each incoming telephone conductor and each bridge tap conductor, respectively.

The present invention further provides a bridge for coupling a pair of incoming telephone conductors to one or more bridge taps, each bridge tap having a conductor coupled to an incoming telephone conductor for distributing a telecommunications signal about a premises, comprising a cable extension connected in series between at least one incoming telephone conductor and at least one respective bridge tap conductor.

The present invention further provides a bridge for coupling a pair of incoming telephone conductors to one or more bridge taps each bridge tap having a conductor coupled to an incoming telephone conductor for distributing a telecommunications signal about a premises, comprising, for each conductor, a cable extension connected in series between the incoming telephone conductor and the bridge tap conductor.

In further aspects of the bridge and cable extension of the invention: the cable extension comprises at least one conductive coil having an impedance matching an impedance of the bridge tap conductor; each incoming telephone conductor is coupled to a bridge tap conductor through one of a plurality of coils; the coils are of different lengths and are selectively coupled between the incoming telephone conductor and the bridge tap conductor by a switch; at least one coil tap is coupled to an intermediate portion of the at least one coil, for selectively varying a number of coil turns between each incoming telephone conductor and each bridge tap conductor; a plurality of coil taps are coupled to different intermediate portions of the at least one coil; switching elements selectively couple a selected length of coil between the telephone conductor and the bridge tap conductor; the switching elements comprise solid state switches; the switching elements are controlled by a processor; the processor detects signal loss due to an unterminated bridge tap by bit error rate testing, and switches to a different coil length when signal loss is detected; the processor detects a change in a state of a bridge tap from terminated to unterminated; and/or the processor detects a change in impedance across the conductors of the bridge tap.

The present invention further provides a method of eliminating cancellation of a telecommunications signal due to reflection at an unterminated bridge tap, wherein a pair of incoming telephone conductors are coupled to one or more bridge taps each bridge tap having a conductor coupled to an incoming telephone conductor for distributing a telecommunications signal about a premises, comprising the step of a. for each conductor, connecting a cable extension in series between the incoming telephone conductor and the bridge tap conductor.

In further aspects of the method of the invention: the cable extension comprises at least one conductive coil having an impedance matching an impedance of the bridge tap conductor; the method includes the step of coupling each incoming telephone conductor to a bridge tap conductor through one of a plurality of coils; the coils are of different lengths and are coupled in parallel between the incoming telephone conductor and the bridge tap conductor; the method includes the step of coupling the bridge tap conductor to at least one coil tap coupled to an intermediate portion of the at least one coil, for selectively varying a number of coil turns between the incoming telephone conductor and the bridge tap conductor; the method includes the step of coupling a plurality of coil taps to different intermediate portions of the at least one coil; the method includes the step of switching to a selected coil length coupled between the incoming telephone conductor and the bridge tap conductor; switching is effected by switching elements comprising solid state switches; the method includes the step of controlling the switching elements by a processor; the method includes the step of detecting signal loss due to an unterminated bridge tap by bit error rate testing, and switching to a selected coil length when said signal loss is detected; the method comprises the step of detecting a change in a state of a bridge tap from terminated to unterminated; and/or the method comprises the step of detecting a change in impedance across the conductors of the bridge tap.

### BRIEF DESCRIPTION OF THE DRAWINGS

In drawings which illustrate by way of example only a preferred embodiment of the invention,

FIG. 1 is a schematic diagram of a local bridge showing an unterminated bridge tap,

FIG. 2A is a circuit diagram of a first preferred embodiment of the device of the invention utilizing a single coil pair,

FIG. 2B is a circuit diagram of a further preferred embodiment of the device of the invention utilizing a single coil,

FIG. 3 is a circuit diagram of a further preferred embodiment of the device of the invention having multiple coil pairs for selectively extending the length of the bridge tap, and

FIG. 4 is a circuit diagram of a further preferred embodiment of the device of the invention having a coil pair with multiple taps for selectively extending the length of the bridge tap.

### DETAILED DESCRIPTION OF THE INVENTION

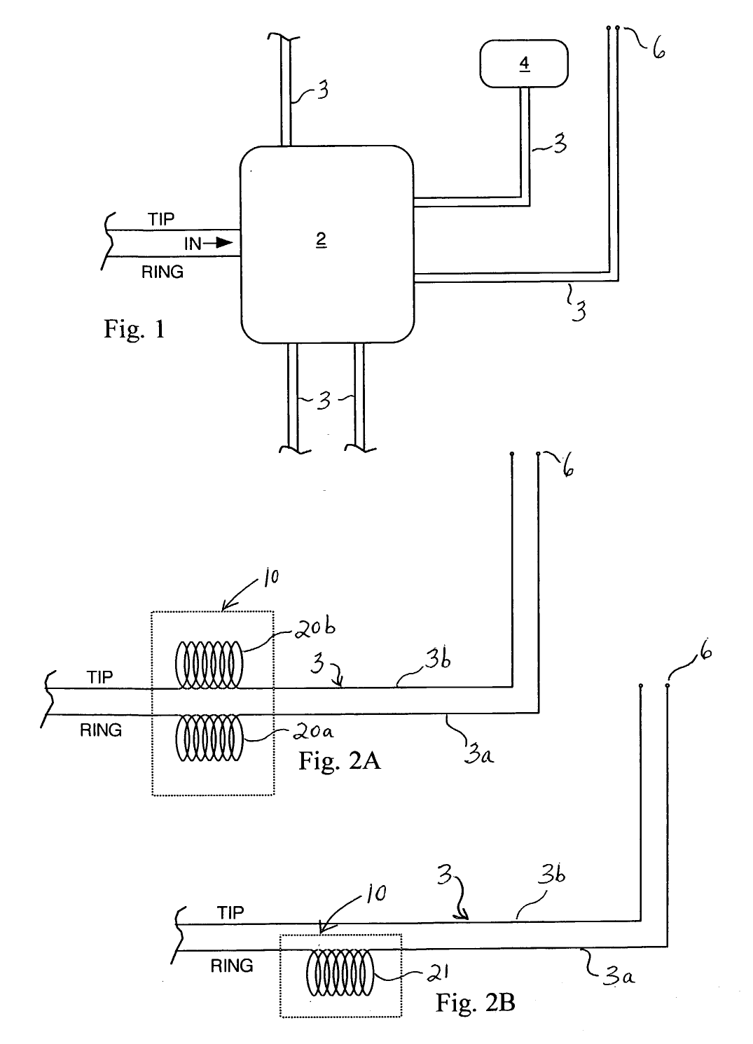

FIG. 1 illustrates a typical telephone bridge 2, for example installed in the basement of a house. The incoming tip and ring telephone lines are coupled to the bridge 2 and bridge taps 3, typically using twisted-pair telephone cable (but potentially using untwisted telephone cable), are coupled to the tip and ring lines at the bridge 2 to couple the telecommunications service to various points in the premises. At the termination of each bridge tap 3 is typically a receptacle (not shown) to which a telephone device 4 (such as a telephone, facsimile machine, answering machine or computer modem) is connected, in order to couple the telephone device 4 to the telecommunications service. Any bridge tap 3 which does not have a telephone device 4 connected to it, for example as at 6 in FIG. 1, is known as a unterminated bridge tap.

The bridge taps 3 can be of varying lengths, depending upon the distance between the bridge 2 and the receptacle and the routing of the telephone cable in the premises. Where the length of the bridge tap approximates an integer multiple of one-quarter of the wavelength of the telecommunications carrier, the unterminated bridge tap 6 will result in catastrophic signal loss within the premises.

FIG. 2A illustrates a first embodiment of a device according to the invention. The device comprises a cable extension 10, in the preferred embodiment comprising at least one coil pair 20, comprising coils 20a, 20b respectively connected in series between the incoming ring and tip lines and the conductors 3a, 3b of the bridge tap 3. In the preferred embodiment the coils 20a, 20b are of the same length, i.e. have the same size and number of turns, and also have an impedance matching the impedance of the conductors 3a, 3b in the bridge tap 3. The cable extension 10 thus serves to increase the effective length of the bridge tap 3, to thereby eliminate cancellation of the telecommunication signal by destruction interference due to signal reflection at the unterminated bridge tap 6.

FIG. 2B illustrates an embodiment of the invention in which the cable extension 10 comprises a single coil 21 connected in series between one of the incoming ring or tip lines and the respective conductor 3a, 3b of the bridge tap 3. In this embodiment the bridge tap 3 is effectively extended by the coil 21, to provide the same effect as in the embodiment of FIG. 2A. However, in the embodiment of FIG. 2B the extended conductor 3a (by way of example in FIG. 2B) is now longer than the conductor 3b, so the bridge tap 3 is no longer symmetrical in relation to the telephone receptacle. This may have an adverse effect on some signals, which could be avoided by the provision of a coil pair 20 as in the embodiment of FIG. 2A.

While it would be possible to interpose a cable extension 10 which is so large that the effective length of the bridge tap 3 must necessarily exceed one quarter of the wavelength of the telecommunications carrier, this is not feasible. The length of the cable extension 10 must be kept within reasonable limits in order to avoid signal loss due to attenuation. Accordingly, for some applications the embodiment of FIG. 2 will be a suitable solution. However, in applications where frequency of the telecommunications signal carrier is undetermined, or where the telecommunications signal frequency may vary, for example in the cable redistribution system described in co-pending U.S. patent application Ser. No. 09/522,940 to Jeffery filed Mar. 10, 2000, which is incorporated herein by reference, certain carriers will still experience reflective cancellation where the extended cable length is an integer multiple of one-quarter of the signal wavelength.

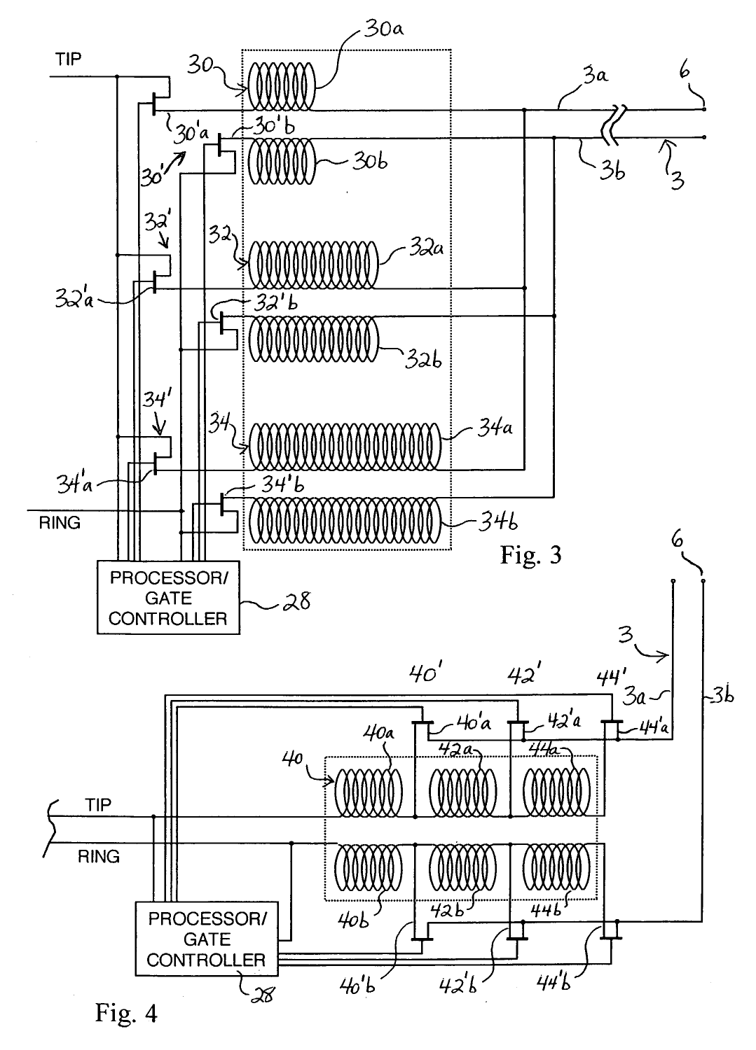

Accordingly, in a further embodiment of the invention illustrated in FIG. 3, the cable extension comprises a plurality of coil pairs 30, 32 and 34. In the preferred embodiment the coils 30a, 30b, 32a, 32b, and 34a, 34b respectively forming each coil pair are of the same length, however the coil pairs 30, 32 and 34 are of different lengths relative to one another. Each coil pair 30, 32 or 34 can be connected between the tip and ring line inputs and the bridge tap 3 by a switching matrix comprising pairs of switches 30′, 32′ and 34′. Each switch pair 30′, 32′, 34′ respectively comprises a pair of switching elements, for example field effect transistors (FETs) 30′a, 30′b; 32′a, 32′b; and 34′a, 34′b.

A microprocessor 28, for example an 8-bit microcontroller such as an Intel 8048 (Trademark) class microcontroller, has its analog or digital input/output (I/O) port coupled to signals from the incoming tip and ring lines. The processor 28 can thus detect the frequency of the telecommunications signal and any change in the frequency of the telecommunications signal. The processor 28 also controls the switching pairs 30′, 32′ and 34′ to couple the selected coil pair 30, 32 or 34, respectively, between the ring and tip lines and the bridge tap conductors 3a, 3b.

The operation of the device of the invention is as follows: One of the coil pairs 30, 32 or 34 is currently connecting the incoming tip and ring lines to the bridge tap conductors 3a, 3b. The microprocessor 28 detects any change in the frequency of the telecommunications signal, calculates one-quarter of the signal wavelength corresponding to the new frequency, and determines whether the current effective cable length of the bridge tap 3 (depending which coil pair 30. 32 or 34 is actively coupled to the bridge tap 3) is an integer multiple of the new carrier frequency. If the microprocessor 28 determines that the cable length of the bridge tap 3 approximates an integer multiple of one-quarter of the wavelength corresponding to the new carrier frequency, the microprocessor 28 switches off the current coil pair 30, 32 or 34 and switches to a new coil pair 30, 32 or 34 by activating the switching pair (30′ in the case of coil pair 30; 32′ in the case of coil pair 32; and 34′ in the case of coil pair 34) corresponding to the coil pair 30, 32 or 34 desired to create an effective bridge tap length which does not approximate an integer multiple of one-quarter of the wavelength of the new carrier.

It will be appreciated that the switching elements 30′a, 32′a, 34′a and 30′b, 32′b 34′b can be any suitable switching device, FETs being preferred for their low cost and fast response. However, other commercially available transistors, matrix switchers, and even mechanical relays can be used as switching elements. It is also possible to use low pass filters as switching elements, to block the high frequency signals from all but one of the coil pairs 30, 32 or 34. Any switching means capable of selectively connecting the coil pair 30, 32 or 34 in series between the ring and tip lines and the conductors of the bridge tap 3, either through the full spectrum or at selected frequencies, can be employed to vary the effective length of the bridge tap 3 in the manner described above.

FIG. 4 illustrates a further embodiment of the invention in which a coil pairs 40, 42 and 44 are connected in series. In this case switching pairs 40′, 42′ and 44′ each respectively comprising switching elements (for example FETs) 40′a, 40′b, 42′a and 42′b, 44′a and 44′b are connected between coils 40a, 40b; 42a, 42b; and 44a, 44b. The tip and ring inputs are coupled to the first coil pair 40. It will be appreciated that this embodiment can equally be considered as a single coil pair having taps though switching pairs 40′, 42′ and 44′, effectively providing a plurality of coil pairs 40, 42 and 44 connected in series, with the same effect.

The operation of the embodiment of FIG. 4 is similar to the embodiment of FIG. 3, except that the microprocessor 28 switches switching elements to actively couple one or more coil pairs (for example only coil pair 40, or both coil pairs 40 and 42, or all three coil pairs 40, 42 and 44) between the ring and tip lines and the conductors of the bridge tap 3, to thereby increase the effective length of the bridge tap 3 in increments corresponding to the lengths of the coil pairs 40, 42 and 44.

In the preferred embodiment, the microprocessor 28 will periodically sample one or more characteristics of each bridge tap 3 which changes when a telephone device 4 is unplugged from the receptacle, for example the line impedance across the two conductors 3a, 3b. The microprocessor 28 can thus detect a change in status of a bridge tap 3 from terminated (having a measurable impedance) to unterminated (having an infinite impedance), and can compensate by coupling an appropriate portion of the cable extension 10 to the unterminated bridge tap 3 in the manner described above, if the frequency of the carrier so requires.

It will be appreciated that in the various embodiments shown, in addition to the cable extension 10 the microprocessor 28 can be programmed to switch to a mode in which the ring and tip lines are connected directly to the bridge tap 3, to render the effective length of the bridge tap 3 equal to its actual length. One or more coil pairs can then be interposed by switching in the manner described above, to increase the effective length of the bridge tap 3 as desired in response to a change in the telecommunications carrier frequency.

A preferred embodiment of the invention has been described by way of non-limiting example only. Those skilled in the art will appreciate that certain modifications and adaptations may be made without departing from the scope of the invention as claimed.

We claim:

1. For a bridge for coupling a pair of incoming telephone conductors to one or more bridge taps, each bridge tap having a conductor coupled to an incoming telephone conductor for distributing a telecommunications signal about a premises,
a cable extension connected in series between at least one incoming telephone conductor and at least one respective bridge tap conductor.

2. The cable extension of claim 1 wherein a cable extension is connected in series between each incoming telephone conductor and each bridge tap conductor, respectively.

3. The cable extension of claim 2 wherein the cable extension comprises at least one conductive coil having an impedance matching an impedance of the bridge tap conductor.

4. The cable extension of claim 3 wherein each incoming telephone conductor is coupled to a bridge tap conductor through one of a plurality of coils.

5. The cable extension of claim 4 wherein the coils are of different lengths and are selectively coupled between the incoming telephone conductor and the bridge tap conductor by a switch.

6. The cable extension of claim 3 comprising at least one coil tap coupled to an intermediate portion of the at least one coil, for selectively varying a number of coil turns between each incoming telephone conductor and each bridge tap conductor.

7. The cable extension of claim 6 comprising a plurality of coil taps coupled to different intermediate portions of the at least one coil.

8. The cable extension of claim 3 comprising switching elements for selectively coupling a selected length of coil between the telephone conductor and the bridge tap conductor.

9. The cable extension of claim 8 wherein the switching elements comprise solid state switches.

10. The cable extension of claim 9 wherein the switching elements are controlled by a processor.

11. The cable extension of claim 10 wherein the processor detects signal loss due to an unterminated bridge tap by bit error rate testing, and switches to a different coil length when signal loss is detected.

12. The cable extension of claim 11 wherein the processor detects a change in a state of a bridge tap from terminated to unterminated.

13. The cable extension of claim 12 wherein the processor detects a change in impedance across the conductors of the bridge tap.

14. A bridge for coupling a pair of incoming telephone conductors to one or more bridge taps each bridge tap having a conductor coupled to an incoming telephone conductor for distributing a telecommunications signal about a premises, comprising a cable extension connected in series between at least one incoming telephone conductor and at least one respective bridge tap conductor.

15. The bridge of claim 14 wherein the cable extension comprises, for each conductor, a cable extension connected in series between the incoming telephone conductor and the respective bridge tap conductor.

16. The bridge of claim 15 wherein the cable extension comprises at least one conductive coil having an impedance matching an impedance of the bridge tap conductor.

17. The bridge of claim 16 wherein each incoming telephone conductor is coupled to a bridge tap conductor through one of a plurality of coils.

18. The bridge of claim 17 wherein the coils are of different lengths and are coupled in parallel between the incoming telephone conductor and the bridge tap conductor.

19. The bridge of claim 16 comprising at least one coil tap coupled to an intermediate portion of the at least one coil, for selectively varying a number of coil turns between the incoming telephone conductor and the bridge tap conductor.

20. The bridge of claim 19 comprising a plurality of coil taps coupled to different intermediate portions of the at least one coil.

21. The bridge of claim 16 comprising switching elements for selectively coupling a selected length of coil to the bridge tap conductor.

22. The bridge of claim 21 wherein the switching elements comprise solid state switches.

23. The bridge of claim 22 wherein the switching elements are controlled by a processor.

24. The bridge of claim 23 wherein the processor detects signal loss due to an unterminated bridge tap by bit error rate testing, and switches to a different coil length when signal loss is detected.

25. The bridge of claim 24 wherein the processor detects a change in a state of a bridge tap from terminated to unterminated.

26. The bridge of claim 25 wherein the processor detects a change in impedance across the conductors of the bridge tap.

27. A method of eliminating cancellation of a telecommunications signal by destructive interference due to reflection at an unterminated bridge tap, wherein a pair of incoming telephone conductors are coupled to one or more bridge taps each bridge tap having a conductor coupled to an incoming telephone conductor for distributing a telecommunications signal about a premises, comprising the step of
a. connecting a cable extension in series between at least one incoming telephone conductor and at least one respective bridge tap conductor.

28. The method of claim 27 comprising the step of, for each conductor, connecting a cable extension in series between the incoming telephone conductor and the respective bridge tap conductor.

29. The method of claim 28 wherein the cable extension comprises at least one conductive coil having an impedance matching an impedance of the bridge tap conductor.

30. The method of claim 29 including the step of coupling each incoming telephone conductor to a bridge tap conductor through one of a plurality of coils.

31. The method of claim 30 wherein the coils are of different lengths and are coupled in parallel between the incoming telephone conductor and the bridge tap conductor.

32. The method of claim 29 comprising the step of coupling the bridge tap conductor to at least one coil tap coupled to an intermediate portion of the at least one coil, for selectively varying a number of coil turns between the incoming telephone conductor and the bridge tap conductor.

33. The method of claim 32 comprising the step of coupling a plurality of coil taps to different intermediate portions of the at least one coil.

34. The method of claim 29 comprising the step of switching to a selected coil length coupled between the incoming telephone conductor and the bridge tap conductor.

35. The method of claim 34 wherein switching is effected by switching elements comprising solid state switches.

36. The method of claim 35 comprising the step of controlling the switching elements by a processor.

37. The method of claim 36 comprising the step of detecting signal loss due to an unterminated bridge tap by bit error rate testing, and switching to a selected coil length when said signal loss is detected.

38. The method of claim 37 comprising the step of detecting a change in a state of a bridge tap from terminated to unterminated.

39. The method of claim 38 comprising the step of detecting a change in impedance across the conductors of the bridge tap.
